(19) United States
(12) Patent Application Publication
(10) Pub. No.: US 2007/0267764 A1
(43) Pub. Date: Nov. 22, 2007

(54) Mold for photocuring nano-imprint and its fabrication process

(75) Inventor: Kenichi Morimoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: DAI NIPPON PRINTING CO., LTD.

(21) Appl. No.: 11/585,871

(22) Filed: Oct. 25, 2006

(30) Foreign Application Priority Data
Oct. 25, 2005 (JP) 2005-309774

(51) Int. Cl. B29D 11/00; G03C 5/00

(52) U.S. Cl. 264/1.1; 249/60; 430/319; 430/320; 430/321; 430/322

(57) ABSTRACT

The invention relates to a mold that has an improved releasability for a photocured resin and an improved robustness. First, an electron beam resist 17 is coated on a quartz substrate 15 having the nature of being transmissive to ultraviolet light. A resist pattern 17a is formed by irradiation with electron beams. Thereafter, the quartz substrate is dry etched using etching gas such as carbon tetrafluoride to form a pattern 15a on the quartz substrate 15. A photocatalytic titanium oxide film 11 is formed as by sputtering on the surface of the quartz substrate 15 with the pattern 15a formed on it to fabricate an NIL mold 10.

### BACKGROUND OF THE INVENTION

The present invention relates to a mold for photocuring nano-imprint and its fabrication process.

With the remarkable progress of microfabrication, as fine as 100 nm resolution is now achievable by photolithography, and so is as fine as 10 nm resolution with electron beams. However, systems used with such photolithography costs much, and less costly fabrication technologies are still in need. For this reason, the formation of desired circuit patterns or the like on silicon or other substrates is being attempted using a nano-imprint technology that is adapted to embody much finer structure than could be possible with a conventional press technology. With this technology, there is in itself no limit to resolution, and the resolution is determined depending on the fabrication precision of a mold. That is, only if a reasonable mold can be fabricated, it would then be possible to form ultra-fine structure more easily than could be possible with conventional photolithography and with much more inexpensive equipment than ever before.

Nano-imprint is roughly classified into, for instance, thermal imprint, photocuring imprint, and soft lithography (for instance, see non-patent publication 1). For instance, Chou, et al. at the University of Minnesota, U.S.A have come up with a thermal nano-imprint technique using a thermoplastic resin (for instance, see patent publication 1), and Willson, et al. at the University of Texas, U.S.A have made public a photocuring nano-imprint technique using an ultraviolet light curing resin (for instance, patent publication 2).

Photocuring nano-imprint is now explained. FIG. 7 is illustrative in section of a mold for nano-imprint lithography used for photocuring nano-imprint (hereinafter referred to as the NIL mold for short). As shown in FIG. 7, an NIL mold 20 is formed with a fine, three-dimensional-shaped pattern 25a on its surface. For photocuring (UV) nano-imprint, the NIL mold 20 is formed of a transparent material in such a way that a portion of it covered with the NIL mold 20 is exposed to a radiation source such as an ultraviolet light source.

FIG. 8 is illustrative of steps of forming the desired pattern on a silicon substrate, using the NIL mold 20.

As depicted in FIG. 8(a), a photocuring resin 33 is coated on a silicon substrate 35. Then, as depicted in FIG. 8(b), the NIL mold 20 is pressed onto the silicon substrate 35 with the photocuring resin 33 coated on it. And then, the photocuring resin 33 is irradiated with ultraviolet light 36 for its curing. Then, as depicted in FIG. 8(c), the NIL mold 20 is taken off to obtain the desired pattern on the photocured resin 33. At a residual film site 37 here, depicted in FIG. 8(c), there is a residual film 39 of the photocured resin 33. To remove the residual film 39, as depicted in FIG. 8(d), RIE (reactive ion etching) 41 is implemented using oxygen gas. As a result, the residual film 39 is removed off to leave the surface of the silicon substrate 35 exposed. Using the rest 33a of the photocured resin as a mask, etching is applied to the silicon substrate 35 to obtain a patterned silicon substrate 35, as depicted in FIG. 8(e).

A problem here is that when the NIL mold 20 is taken off from the state with the NIL mold 20 pressed onto the resin as depicted in FIG. 8(b), there is the photocured resin 33 remaining partly stuck onto the NIL mold 20, as shown in FIG. 9, with the result that it becomes difficult to form the desired pattern.

For the purpose of improving the releasability of the NIL mold 20 off the photocured resin 33, a releasing agent such as fluororesin has thus been coated on the surface of the NIL mold 20.

FIG. 10 is illustrative of exemplary steps of coating the releasing agent such as fluororesin onto the NIL mold 20. First, the NIL mold 20 depicted in FIG. 10(a) is washed with acetone, and oxygen RIE or ozone cleaning is then applied to its surface for removal of surface organic matter. Afterwards, as depicted in FIG. 10(b), the NIL mold 20 is dipped in a releasing agent 27. The releasing agent 27 here, for instance, includes Optool DSX (Daikin Industries Co., Ltd.) comprising a fluorine compound, and diluted with a Demnum solvent.

Afterwards, as depicted in FIG. 10(c), the NIL mold 20 is placed in a water bath containing distilled water 29 at 65° C. for 1 hour. Further, as depicted in FIG. 10(d), the NIL mold 20 is washed in a solvent 31. The solvent 31 here is the same as the Demnum solvent solution used for the dilution of the releasing agent in FIG. 10(b). This allows an extra releasing agent 27 on the surface of the NIL mold 20 to be removed off.

After that, drying treatment is carried out to provide the monomolecular releasing agent film formed on the NIL mold 20, as depicted in FIG. 10(e) (for instance, see non-patent publication 1).

A problem with coating the fluororesin onto the NIL mold 20 is, however, that there is no adequate adhesion between the NIL mold 20 and the fluororesin. In other words, the fluororesin improves on releasability for the photocured resin because of its small surface energy; however, that releasing effect works on the mold, too. For this reason, when the NIL mold 20 is taken off from the state with the NIL mold 20 pressed onto the photocured resin 33, the fluororesin itself may possibly peel off the NIL mold 20. Problems with coating by dipping are, on the other hand, that the coated film becomes uneven, robustness drops due to the aforesaid peeling-off, or the like.

Patent Publication 1
U.S. Pat. No. 5,772,905

Patent Publication 2
Japanese Translation of PCT Internal Application No. 2002-539604

Patent Publication 3
JP(A) 7-303835

Patent Publication 4
JP(A) 2003-49265

Non-Patent Publication 1

Shinji Matsui, “OYO BUTURI”, Vol. 74, No. 4, “New approach of chip fabrication—Nanoimprint technology and its application”, The Japan Society of Applied Physics, Apr. 10, 2005

### SUMMARY OF THE INVENTION

In view of such problems as mentioned above, an object of the invention is to provide a mold for photocuring nano-imprint having a high releasibility with respect to a photocuring (photocured) resin and an improved robustness, and its fabrication process.

According to the first invention for the accomplishment of the above object, there is a mold for photocuring nano-imprint provided, which is characterized by comprising:

a pattern of three-dimensional configuration formed on an upper surface of a light transmissive substrate, and a photocatalytic substance film formed on said pattern of three-dimensional configuration.

The photocatalytic substance here has a crystal structure, including photocatalytic titanium oxide or the like.

The light transmissive substrate here is made up of an ultraviolet light transmissive substance such as quartz, soda-lime glass, low-expansion glass or a variety of other glasses, or a combination of them.

The photocatalytic substance is one that, upon irradiation with light of a wavelength having an energy greater than a specific band gap, generates electrons or positive holes by way of photoexcitation. Reducing power that electrons generated by photoexcitation have or oxidizing power that positive holes have triggers photo-catalytic reactions such as decomposition, purification, etc. of organic matter (for instance, see patent publication 3).

The photocatalytic substance here, for instance, is photocatalytic titanium oxide. Meant by the photo-catalytic titanium oxide is one of titanium oxide species that has a crystal structure. Non-crystal type titanium oxide is inadequate in terms of photocatalytic performance. The photocatalytic titanium oxide generates, upon irradiation with light of a wavelength having an energy greater than its band gap, electrons at a conduction band and positive holes at a valence band by way of photo-excitation. The electrons generated by that photo-excitation have a strong reducing power, and the positive holes have a strong oxidizing power: both have an effect on the decomposition, and purification of organic matter or the like.

Preferable for the light of a wavelength having an energy greater than the band gap is light containing ultraviolet radiation, and more preferable is light having a wavelength range containing a near-ultraviolet ray of 300 nm to 400 nm. Light in this wavelength range is the same as that used primarily for photocuring nano-imprint.

Therefore, if a photocatalytic titanium oxide film is formed on the surface of the mold for photocuring nano-imprint, it is then possible to prevent sticking of the photocured resin onto the surface of the mold, because it is exposed to ultraviolet light for each pattern transfer process; that is, even when the photocuring resin is pressed onto the mold, the power of binding organic matter (photocured resin) to the surface of the mold is permitted to wane by way of the photocatalytic effect so that the sticking of the photocured resin onto the surface of the mold can be prevented.

The organic substance that is decomposed by the photocatalytic titanium oxide with such irradiation of light as mentioned above, for instance, includes organic halogen compounds, organic phosphorus compounds, hydrocarbons such as surfactants or oils, aldehydes, mercaptans, alcohols, amines, amino acids, and proteins. Thus, the photocatalytic titanium oxide film exhibits a high releasability for the photocured resin that is an organic substance but a low releasability for quartz or glass that is an inorganic substance. With the photo-catalytic titanium oxide film, therefore, the problem with the fluororesin coating film that comes to peel off would be eliminated.

The second invention is directed to a process for the fabrication of a mold used for photocuring nano-imprint, characterized by comprising:

a step (a) of forming a pattern of three-dimensional configuration on an upper surface of a light transmissive substrate, and

a step (b) of a photocatalytic substance film on said pattern of three-dimensional configuration.

At the step (a), various techniques used for semiconductor lithography may be used. For instance, the step (a) comprises a sub-step of coating an electron beam resist, an ultraviolet light resist, an X-ray resist or the like on the upper surface of the light transmissive substrate, a sub-step of irradiating the electron beam resist, ultraviolet light resist or X-ray resist with electron beams, ultraviolet light, X-rays or the like to form the desired resist pattern, a sub-step of using that resist pattern as a mask to etch the light transmissive substrate dry or wet, and a sub-step of resist removal.

Preferably, the step (a) should comprise a sub-step of coating the electron. beam resist on the upper surface of the light transmissive substrate, a sub-step of irradiating the electron beam resist with electron beams to form the resist pattern, a sub-step of using that resist pattern as a mask to dry etch the light transmissive substrate, and a sub-step of resist removal.

Alternatively, the step (a) may comprise a sub-step of forming an electrically conductive layer on the upper surface of the light transmissive substrate, a sub-step of coating the electron beam resist on the upper surface of the conductive layer, a sub-step of irradiating the electron beam resist with electron beams to form the resist pattern, a sub-step of conductive layer removal, and a sub-step of using that resist pattern as a mask to dry etch the light transmissive substrate.

By the provision of that electrically conductive layer, inconveniences caused by electrification by electron beam irradiation, for instance, changes in the size and position of the desired pattern can be eliminated.

For that electrically conductive layer, for instance, Cr, Ti, Ta, Mo, W, and Zr, and a combination of them may be used.

At the step (b), the photocatalytic substance film is formed by, for instance, sputtering, vacuum deposition, or thermal decomposition spray.

Preferably, the step (b) should comprise a sub-step of forming a non-crystal type titanium oxide film by sputtering, and a sub-step of forming a photocatalytic titanium oxide film having a crystal structure by sintering.

Although a titanium oxide film capable of being formed under general film-formation conditions is predominantly of the non-crystal type, it can be crystallized by sintering (for instance, see patent publication 4).

The invention also encompasses a pattern transfer process wherein by photocuring nano-imprint using such a mold as described above, the pattern of three-dimensional configuration on the mold is transferred onto another object. Further, the invention involves a semiconductor component with a circuit pattern formed by that pattern transfer process, an optical device with an optical pattern formed by it, a magnetic recording medium with a data track pattern formed by it, a biochip with a cell pattern formed by it, or the like.

According to the invention as described above, it is possible to provide a mold for photocuring nano-imprint that has an improved releasability for the photocuring (photocured) resin and an improved robustness as well, and its fabrication process.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is illustrative in section of the NIL mold according to one embodiment of the invention.

FIG. 2 is illustrative of how to fabricate the NIL mold of FIG. 1.

FIG. 3 is a flowchart of how to fabricate the NIL mold of FIG. 1.

FIG. 4 is illustrative of another fabrication process using the NIL mold of FIG. 1.

FIG. 5 is illustrative of how to form a pattern on a silicon substrate, using the NIL mold of FIG. 1.

FIG. 6 is illustrative of why a photocured resin is not stuck onto the surface of the NIL mold of the invention at the time when that NIL mold is used.

FIG. 7 is a sectional view of a conventional NIL mold.

FIG. 8 is illustrative of how to form a pattern on a silicon substrate, using a conventional NIL mold.

FIG. 9 is illustrative of problems with the formation of a pattern using a conventional NIL mold.

FIG. 10 is illustrative of how to form a releasing film on a conventional NIL mold.

### DESCRIPTION OF THE PREFERRED EMBODIMENTS

With reference to the accompanying drawings, detailed accounts are now given of the NIL mold 10 according to some embodiments of the invention and its fabrication process. In the following disclosure, the invention will first be described with reference to one embodiment wherein quartz is used as the light transmissive substrate and a photocatalytic titanium oxide film is used as the photocatalytic substance film.

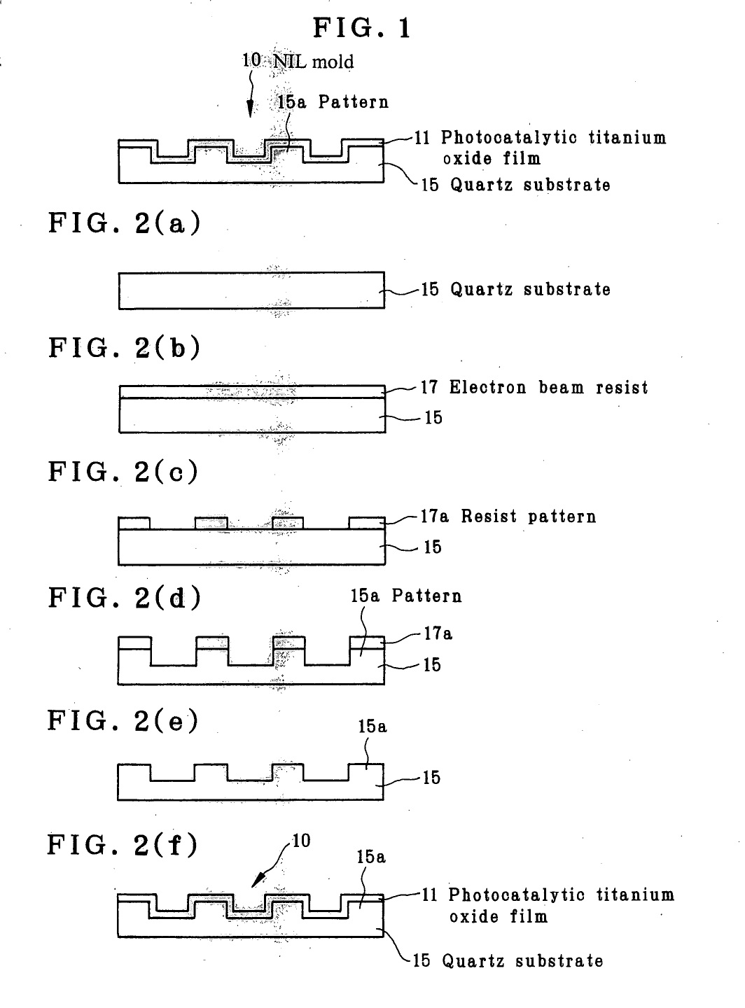

FIG. 1 is illustrative in section of the NIL mold 10, in which a photocatalytic titanium oxide film 11 is formed on the surface of a pattern 15a. The pattern 15a comprises a fine, three-dimensional configuration formed as by etching on a quartz substrate 15.

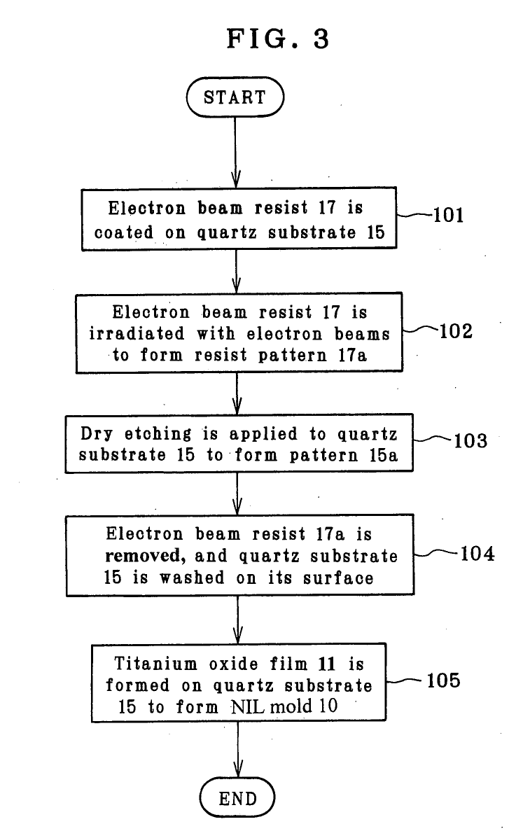

Then, how to fabricate the NIL mold 10 is explained with reference to FIGS. 2 and 3.

FIG. 2 is illustrative of steps for the fabrication of the NIL mold 10, and FIG. 3 is a flowchart of how to fabricate the NIL mold 10.

As depicted in FIG. 2(a), there is a quartz substrate 15 provided at the ready. Then, as depicted in FIG. 2(b), an electron beam resist 17 is coated on the surface of the quartz substrate 15 (step 101). Then, as depicted in FIG. 2(c), a desired portion of the electron beam resist 17 is irradiated with electron beams, and thereafter developed to from a resist pattern 17a on the quartz substrate 15 (step 102).

Then, as depicted in FIG. 2(d), the resist pattern 17a is used as a mask to dry etch the quartz substrate 15 to form a pattern 15a (step 103). For the etching gas here, carbon tetrafluoride (CF₄) is used. Then, an unnecessary portion of the electron beam resist 17 is removed off. Further, the surface of the quartz substrate 15 is washed to obtain a quartz substrate 15 having such a pattern 15a as depicted in FIG. 2(e) (step 104). Then, a photocatalytic titanium oxide film 11 is formed by sputtering and sintering on the surface of the quartz substrate 15 having the pattern 15a of FIG. 2(e) formed on it, thereby obtaining an NIL mold 10 depicted in FIG. 2(f) (step 105).

As already described, the photocatalytic titanium oxide film 11 is formed by sputtering. Specifically, a titanium target is used as the target; argon or other rare gas and oxygen gas are used as the sputtering gas; and the input power density is set at 6 W/cm² or higher. The film formed by sputtering under those film-formation conditions is predominantly a non-crystal type titanium oxide film. To crystallize it in the form of a photocatalytic titanium oxide film having an improved photocatalytic performance, it is sintered at a temperature ranging from 300° C. to 600° C. At a sintering temperature of lower than 300° C., it is likely that the resultant catalytic performance may become inadequate, and at a sintering temperature exceeding 600° C., softening or the like may possibly take place although depending on the substrate material used. Note here that the quartz substrate has a softening point of about 1,600° C. The finally obtained photocatalytic titanium oxide film 11 has preferably a thickness of 1 to 5 nm.

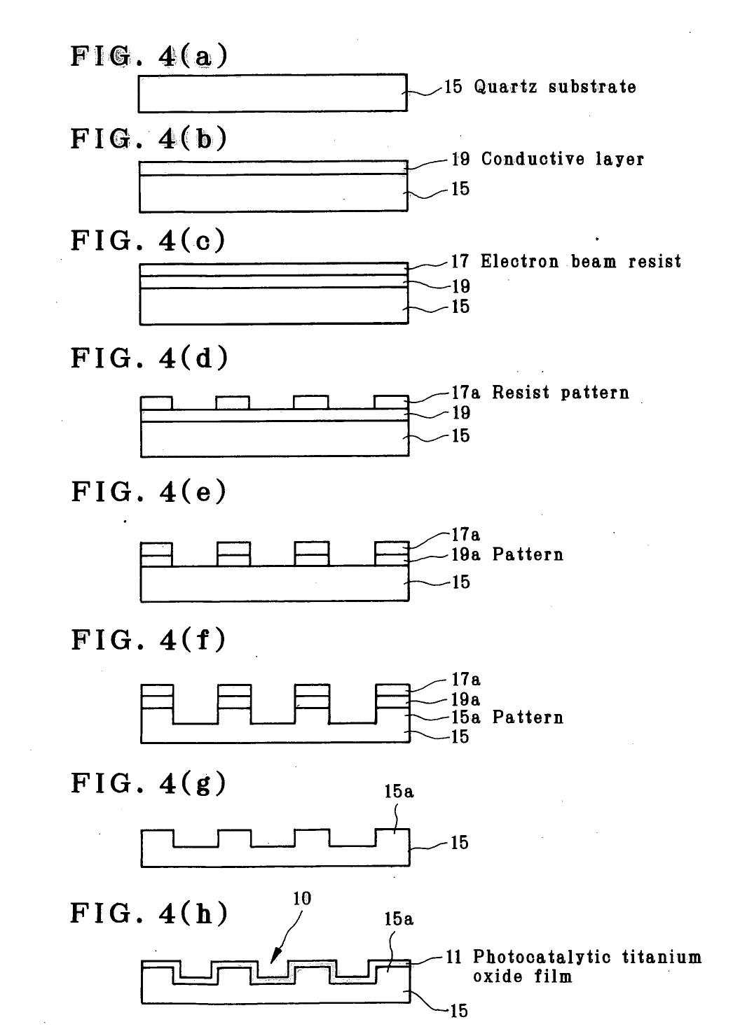

Another fabrication process for the NIL mold 10 is now explained with reference to FIG. 4. Here, how to provide an electrically conductive layer for antistatic purposes is explained.

FIG. 4 is illustrative of steps in another fabrication process for the NIL mold 10.

As depicted in FIG. 4(a), a quartz substrate 15 is provided at the ready. Then, as depicted in FIG. 4(b), a Cr film is formed as an electrically conductive layer 19 by sputtering. Then, as depicted in FIG. 4(c), an electron beam resist 17 is coated on the surface of the quartz substrate 15 (on the conductive layer 19). Then, as depicted in FIG. 4(d), a desired portion of the electron beam resist 17 is irradiated with electron beams to form a resist pattern 17a by way of a development step.

Then, as depicted in FIG. 4(e), the resist pattern 17a is used as a mask to apply etching to the conductive layer 19, thereby forming a pattern 19a. Then, as depicted in FIG. 4(f), the quartz substrate 15 is dry etched using etching gas such as CF₄ to form a pattern 15a on the quartz substrate 15. Then, the electron beam resist 17 and conductive layer 19 are removed off followed by surface washing. Then, a photocatalytic titanium oxide film 11 is formed on the surface of the quartz substrate 15 of FIG. 4(g) with the pattern 15a formed on it to obtain an NIL mold 10 depicted in FIG. 4(h).

As depicted at step 102 of FIG. 3 as an example, electron beams are often bent by the electrification of the quartz substrate 15 that is an insulator at the time of electron beam lithography. Once the electron beams have been bent, the written pattern often differ from what should be in terms of size and position. With the embodiment here wherein, as depicted in FIG. 4, the electrically conductive layer 19 is provided in the process of forming the NIL mold 10, it is possible to prevent electrification of the quartz substrate 15, thereby making sure precise electron beam lithography.

In the NIL mold 10 obtained through the aforesaid process, the photocatalytic titanium oxide film 11 is formed on the pattern 15a of fine, three-dimensional configuration formed on the quartz substrate 15.

How to use such NIL mold 10 to form a pattern on a silicon substrate 35 is the same as described with reference to FIG. 8. That is, the NIL mold 10 is used in lieu of the NIL mold 20 in FIG. 8 to form a pattern on the silicon substrate 35.

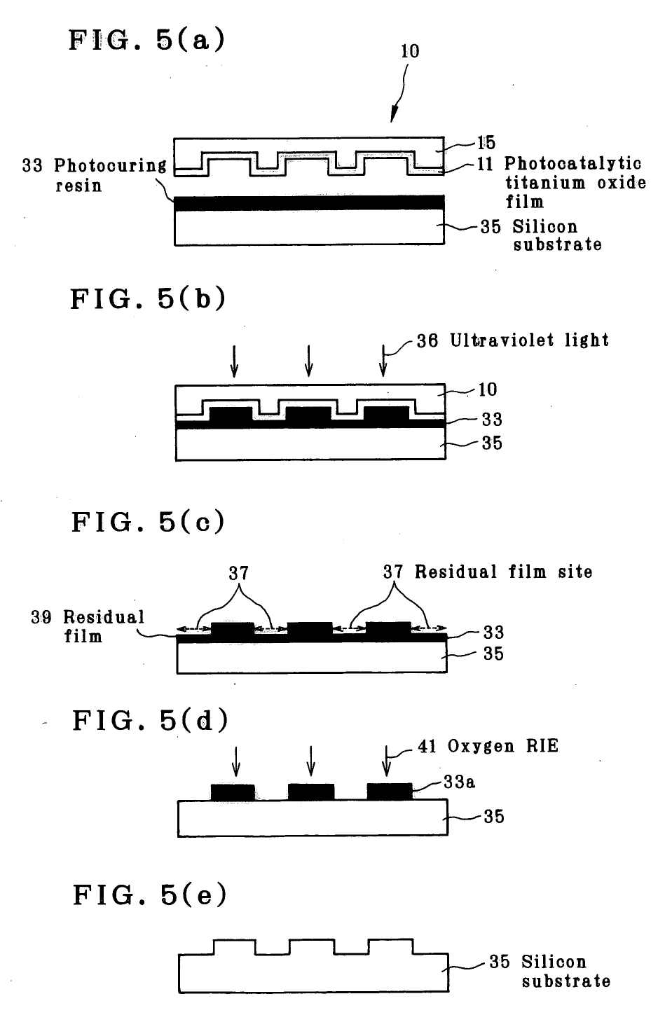

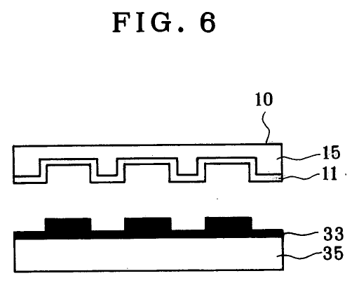

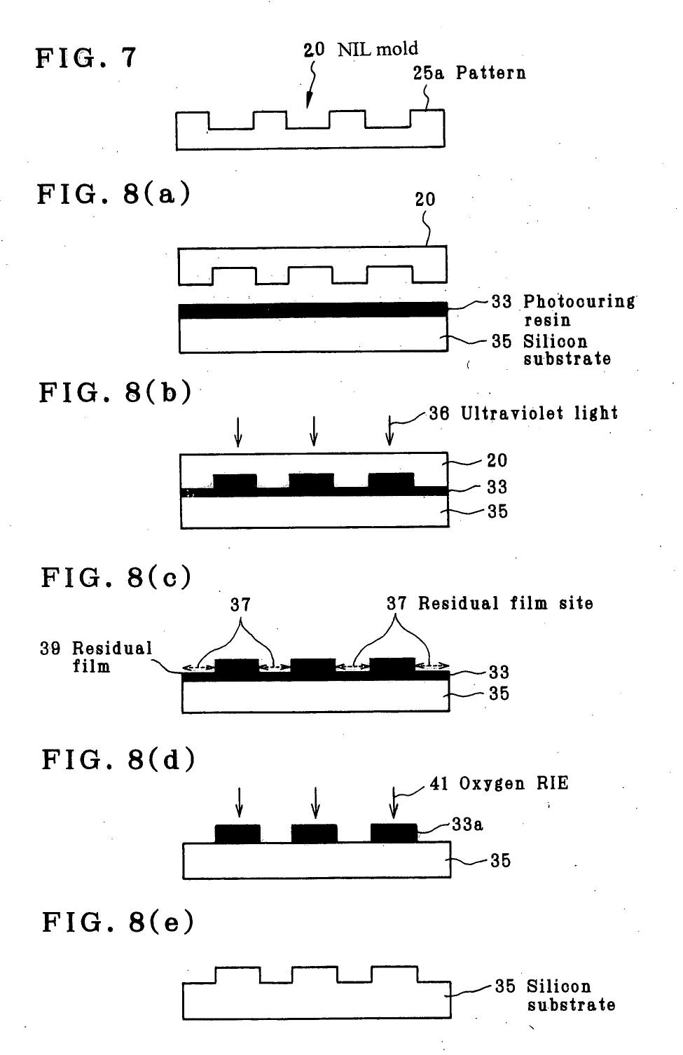

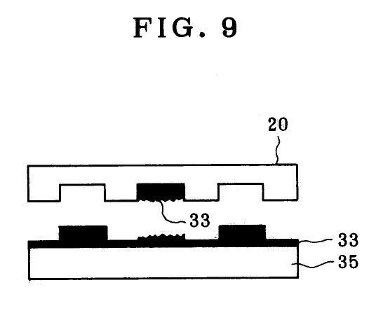

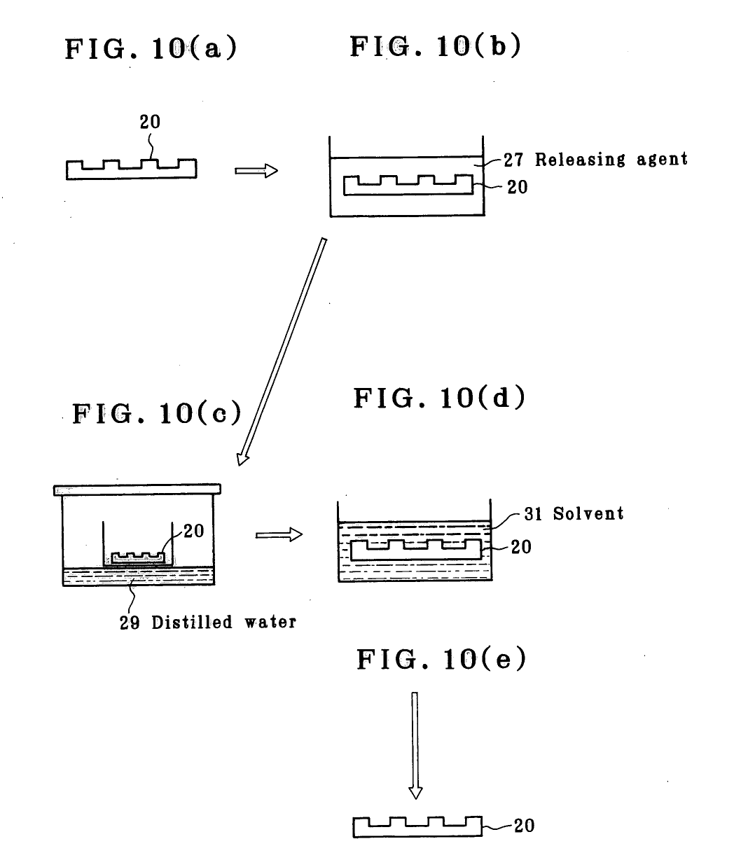

More specifically, as depicted in FIG. 5(a), a photocuring resin 33 is coated on a silicon substrate 35. Then, as depicted in FIG. 5(b), the NIL mold 10 with a photocatalytic titanium oxide film 11 formed on it is pressed onto the silicon substrate 35 with the photocuring resin 33 coated on it. And then, the photocuring resin 33 is irradiated with ultraviolet light 36 for its curing. Then, as depicted in FIG. 5(c), the NIL mold 10 is taken off to obtain the desired pattern on the photocured resin 33. On a residual film site 37 here, depicted in FIG. 5(c), there is a residual film 39 of the photocured resin 33. To remove the residual film 39, as depicted in FIG. 5(d), RIE (reactive ion etching) 41 is implemented using oxygen gas. As a result, the residual film 39 is removed off to leave the surface of the silicon substrate 35 exposed. Using the rest 33a of the photocured resin as a mask, etching is applied to the silicon substrate 35 to obtain a patterned silicon substrate 35, as depicted in FIG. 5(e).

As the NIL mold 10 is irradiated with ultraviolet light 36 at the step of FIG. 5(c), there is a photo-catalytic reaction occurring on the surface of the photo-catalytic titanium oxide film 11. For this reason, even when there is the photocured resin 33 tending to stick to the surface of the NIL mold 10, that photocatalytic reaction works for breaking up the sticking or binding power. Therefore, when the NIL mold 10 is taken off from the state of remaining pressed onto the silicon substrate 35, the photocured resin 33 can never be stuck onto the surface of the NIL mold 10. As a result, the releasability of the NIL mold 10 off the photocured resin 33 is more improved.

It is thus possible to prevent the photocured resin 33 from peeling off the silicon substrate 35 while it remains stuck onto the NIL mold 10.

As that photocatalytic reaction takes place, it causes the photocatalytic titanium oxide film 11 to decompose the organic substance; the organic substance present between the photocatalytic titanium oxide film 11 and the photocured resin 33 is decomposed, thereby making sure prevention of contamination due to the sticking of the organic matter onto the silicon substrate 35, too. This is particularly useful for photocuring nano-imprint, because exposure to ultraviolet light (UV) takes place for each imprint.

Further, the NIL mold 10 according to the embodiment here, because of having the photocatalytic titanium oxide film 11, is improved in terms of heat resistance, corrosion resistance, robustness, resistance to damages, wear resistance, and film uniformity. This is because the titanium oxide is a compound that is excellent in strength, heat resistance and corrosion resistance, and chemically stable as well. By use of the NIL mold 10 having the photocatalytic titanium oxide film 11, it is thus possible to obtain a stable, precise transfer pattern even after a plurality of pressing cycles and, hence, cut down fabrication costs.

While pattern transfer to the silicon substrate 35 has been described, it is understood that the aforesaid substrate material is not particularly limited, and a suitable material is preferably selected depending on what purpose patterned components are used for, etc. The patterned components, for instance, find use as semiconductor components, optical devices, magnetic recording media, and biochips. The material used here specifically includes semiconductors such as silicon (Si), gallium arsenide (GaAs), aluminum gallium arsenide (AlGaAs) and gallium nitride (GaN); resins such as polyethylene, polystyrene, polypropylene, polycarbonate, vinyl chloride and PET resin; metals such as titanium (Ti), copper (Cu), iron (Fe), nickel (Ni), aluminum (Al) and chromium (Cr); glasses such as quartz glass and soda-lime glass; and alloys containing them.

### EXAMPLE 1

A novolac resin type electron beam resist (ZEP-520 made by ZEON Co., Ltd.) is coated at a thickness of 100 nm on the surface of a cuboidal quartz substrate having an outside shape of 6 inches in length, 6 inches in width and 0.25 inch in height, then subjected to electron beam lithography, and finally developed to form a line form of resist pattern having a line width of 70 nm.

Then, carbon tetrafluoride (CF₄) is used as etching gas to dry etch the quartz substrate, after which an unnecessary portion of the electron beam resist is ashed off by oxygen gas to obtain a pattern of three-dimensional configuration having a width of 70 nm and a depth of 100 nm.

Then, sputtering is carried out using a titanium target as the target and argon and oxygen as the sputtering gas at an input power density of 7 W/cm², after which sintering is done at 400° C. to obtain a photocatalytic titanium oxide film of 5 nm, in thickness, thereby obtaining a mold according to the invention.

Then, an ultraviolet light curing resin PAK-01 (made>by Toyo Gosei Co., Ltd.) is coated on a silicon wafer of 200 mm in diameter, and the aforesaid mold is pressed onto it, after which that curing resin is irradiated with ultraviolet light of 320 nm in wavelength for its curing. Then, the mold is taken off, and an extra film is removed off by oxygen RIE (reactive ion etching). Finally, etching is applied to the silicon substrate to obtain a silicon substrate on which a pattern of three-dimensional configuration having a width of 70 nm and a depth of 100 nm is formed.

On the other hand, there is no sticking of the ultraviolet light cured resin onto the mold taken off.

### EXAMPLE 2

Cr was sputtered at a thickness of 10 nm on the surface of a cuboidal quartz substrate having an outside shape of 6 inches in length, 6 inches in width and 0.25 inch in height. Afterwards, a novolac resin type electron beam resist (ZEP-520 made by ZEON Co., Ltd.) was coated at a thickness of 100 nm, then subjected to electron beam lithography, and finally developed to form a line-and-space form of resist pattern having a width of 70 nm and a pitch of 140 nm.

The provision of Cr as the electrically conductive layer makes sure an antistatic effect so that the formed line-and-space resist pattern has the desired values in terms of size and position.

Then, carbon tetrafluoride (CF₄) is used as etching gas to dry etch the quartz substrate, after which an unnecessary portion of the electron beam resist is ashed off by oxygen gas and Cr is removed by a chlorine type gas to obtain a line-and-space pattern of three-dimensional configuration having a width of 70 nm, a pitch of 140 nm and a depth of 100 nm.

Then, sputtering is carried out using a titanium target as the target and argon and oxygen as the sputtering gas at an input power density of 7 W/cm², after which sintering is done at 400° C. to obtain a photocatalytic titanium oxide film of 5 nm, in thickness, thereby obtaining a mold according to the invention.

Then, an ultraviolet light curing resin PAK-01 (made by Toyo Gosei Co., Ltd.) is coated on a silicon wafer of 200 mm in diameter, and the aforesaid mold is pressed onto it, after which that curing resin is irradiated with ultraviolet light of 320 nm in wavelength for its curing. Then, the mold is taken off, and an extra film is removed by oxygen RIE (reactive ion etching). Finally, etching is applied to the silicon substrate to obtain a silicon substrate on which a pattern of three-dimensional configuration having a width of 70 nm, a pitch of 140 nm and a depth of 100 nm is formed.

On the other hand, there is no sticking of the ultraviolet light cured resin onto the mold taken off.

Some preferred embodiments of the NIL mold or the like according to the invention have been described with reference to the accompanying drawings, it is understood that the invention is never limited to them. It would be obvious to those skilled in the art that various modifications and changes may be possible within the technical scope of what is disclosed herein, and that they are as a matter course included in the technical scope of the invention.

What we claim is:

1. A mold used for photocuring nano-imprint, characterized by comprising: a pattern of three-dimensional configuration formed on an upper surface of a light transmissive substrate, and a photocatalytic substance film formed on said pattern of three-dimensional configuration.

2. The mold according to claim 1, characterized in that said photocatalytic substance has a crystal structure.

3. The mold according to claim 1, characterized in that said photocatalytic substance is a photocatalytic titanium oxide.

4. The mold according to claim 1, characterized in that said light transmissive substrate comprises quartz.

5. The mold according to claim 1, characterized in that light used for said photocuring nano-imprint is ultraviolet light having a wavelength of 300 nm to 400 nm.

6. A process for fabrication of a mold used for photocuring nano-imprint, characterized by comprising: a step (a) of forming a pattern of three-dimensional configuration on an upper surface of a light transmissive substrate, and a step (b) of a photocatalytic substance film on said pattern of three-dimensional configuration.

7. The mold fabrication process according to claim 6, characterized in that said step (a) comprises: a sub-step of coating an electron beam resist on the upper surface of said light transmissive substrate, a sub-step of irradiating said electron beam resist with electron beams to form a resist pattern, and a sub-step of using said resist pattern as a mask to dry etch said light transmissive substrate.

8. The mold fabrication process according to claim 6, characterized in that said step (a) comprises: a sub-step of forming an electrically conductive layer on the upper surface of said light transmissive substrate, a sub-step of forming an electron beam resist on the upper surface of said conductive layer, a sub-step of irradiating said electron beam resist with electron beams to form a resist pattern, a sub-step of removing said conductive layer, and a sub-step of using said resist pattern as a mask to dry etch said light transmissive substrate.

9. The mold fabrication process according to claim 6, characterized in that at said step (b), said photocatalytic substance film is formed by sputtering.

10. The mold fabrication process according to claim 6, characterized in that said photocatalytic substance has a crystal structure.

11. The mold fabrication process according to claim 6, characterized in that said photocatalytic substance is a photocatalytic titanium oxide.

12. The mold fabrication process according to claim 6, characterized in that said step (b) comprises: a sub-step of forming a non-crystal type titanium oxide film by sputtering, and a sub-step of forming a photo catalytic titanium oxide film having a crystal structure by sintering.

13. The mold fabrication process according to claim 6, characterized in that said light transmissive substrate comprises quartz.

14. A pattern transfer process, characterized in that a pattern of three-dimensional configuration on a mold is transferred onto another object by way of photo-curing nano-imprint using the mold according to claim 1.

15. The pattern transfer process according to claim 14, characterized in that light used for said photo-curing nano-imprint is ultraviolet light having a wavelength of 300 nm to 400 nm.

16. A semiconductor component, characterized in that a circuit pattern is fabricated by the pattern transfer process according to claim 14.

17. An optical device, characterized in that an optical pattern is fabricated by the pattern transfer process according to claim 14.

18. A magnetic recording medium, characterized in that a data track pattern is fabricated by the pattern transfer process according to claim 14.

19. A biochip, characterized in that a cell pattern is fabricated by the pattern transfer process according to claim 14.
